(19) United States
(12) Patent Application Publication
(10) Pub. No.: US 2023/0011760 A1
(43) Pub. Date: Jan. 12, 2023

(54) DEVICE EQUIPPED WITH OPEN AND CLOSE FINGER FOR GUIDING COIL WIRE INTO SLOT

(71) Applicant: TOYOTA JIDOSHA KABUSHIKI KAISHA, Toyota-shi (JP)

(72) Inventor: Masahiro UMEDA, Toyota-shi (JP)

(73) Assignee: TOYOTA JIDOSHA KABUSHIKI KAISHA, Toyota-shi (JP)

(21) Appl. No.: 17/810,936

(22) Filed: Jul. 6, 2022

(30) Foreign Application Priority Data
Jul. 6, 2021 (JP) 2021-112357

(51) Int. Cl. H02K 15/085; H02K 3/12; H02K 5/173; H02K 3/48

(52) U.S. Cl. CPC H02K 15/085; H02K 3/12; H02K 5/173; H02K 3/48

(57) ABSTRACT

In an open and close finger device, fingers are arranged to guide coil wires when the coil wires are respectively inserted into slots in a motor core. A cam plate includes cam slots, each of which is engaged with a cam follower which is fixed to corresponding one of the fingers. When the cam plate is turned, the fingers are advanced along a radial direction while being guided within guide grooves in a finger guide. The cam plate is turned while being guided via a bearing by a cap fixed to the finger guide.

### CROSS REFERENCE TO RELATED APPLICATION

This application claims priority to Japanese Patent Application No. 2021-112357 filed on Jul. 6, 2021, which is incorporated herein by reference in its entirety including the specification, claims, drawings, and abstract.

### TECHNICAL FIELD

The present disclosure relates to fingers arranged to be aligned with end surfaces of teeth in a core of a rotary electric machine and configured to guide coil wires, which are wound around the core, when the coil wires are inserted into slots defined by space between the teeth, and in particular relates to an open and close finger device including fingers configured to be advanced or retracted to a closed position or an open position by an opening and closing mechanism.

### BACKGROUND

In connection with a process of forming a coil in a core of a rotary electric machine, the use of fingers for guiding coil wires when the coil wires are inserted into spaces between adjacent teeth in the core has been known. JP 2005-57950 A (hereinafter referred to as the '950 application) describes a finger opening and closing device including a cam slot plate (2a) in which cam slots (7) are defined and fingers (5) on which cam followers (6) engaged in the cam slots (7) are fixed. In the finger opening and closing device of the '950 application, the fingers (5) are advanced and retracted to be closed and opened by turning the cam slot plate (2a). It should be noted that reference signs within parentheses are only used in the '950 application, and are not related to reference signs used in the following description for explaining embodiments of this application.

In the finger opening and closing device of the '950 application, the cam slot plate (2a) is not sufficiently guided when it is turned, which may cause wear in slidable portions. The present disclosure is directed to smoothly turning a cam slot plate.

### SUMMARY

An open and close finger device according to the present disclosure includes fingers arranged to be respectively aligned with end surfaces of teeth in a core of a rotary electric machine, the fingers being configured to guide coil wires, which are wound around the core, when the coil wires are inserted into slots, each of which is defined by a space between adjacent teeth among the teeth in the core, and further includes a finger guide having guide grooves which are arranged in an array along a circumferential direction and configured to respectively house the fingers, the guide grooves extending along a radial direction to thereby guide radial movement of the fingers, a cam plate formed in an annular plate shape, the cam plate having cam slots, each of which is inclined relative to the radial direction and s configured to fittingly receive a cam follower fixed to corresponding one of the fingers, a cap placed in a fixed position with respect to the finger guide and configured to define an axis of turn of the cam plate which is turned along the circumferential direction, a bearing disposed between the cap and the cam plate to guide the turn of the cam plate along the circumferential direction, and an actuator configured to turn the cam plate for causing the fingers to be advanced and retracted along the radial direction.

When the cam plate is turned by the actuator, the cam followers fitted in the cam slots in the cam plate are accordingly driven through the cam slots, which causes the fingers to be advanced or retracted along the radial direction while being guided along the guide grooves. The fingers advanced inward in the radial direction are brought into a closed state in which the fingers are positioned on the end surfaces of the teeth so as to be aligned therewith, while the fingers retracted outward in the radial direction are brought into an open state.

The presence of the bearing between the cap and the cam plate enables the cam plate to be turned smoothly.

Such smooth turning of the cam plate via the bearing makes the cam plate and components in contact with the cam plate less prone to wear.

The bearing may be a ball bearing or a roller bearing.

The cap may be configured to partially cover open regions of the guide grooves in order to retain the fingers within the guide grooves.

The cap and the bearing may be positioned on a radial inner side of the cam plate.

### BRIEF DESCRIPTION OF DRAWINGS

Embodiments of the present disclosure will be described based on the following figures, wherein:

FIG. 1 shows a stator core and coil segments in a rotary electric machine;

FIG. 2 shows a state in which the coil segments are mounted in the stator core;

FIG. 3 shows a state in which the coil segments are bent to form a coil;

FIG. 4 shows an open and close finger device according to an embodiment;

FIG. 5 shows the open and close finger device according to the embodiment and the coil segments being in an intermediate stage of a process of mounting the coil segments in the stator core;

FIG. 6 shows a finger as a single piece isolated from other fingers;

FIG. 7 is a cross sectional view showing teeth of a stator and fingers which are respectively placed on the teeth;

FIG. 8 is an exploded perspective view showing main components in the open and close finger device;

FIG. 9 shows the finger housed within a guide groove in a finger guide;

FIG. 10 shows a closed state and an open state of the fingers; and

FIG. 11 shows an example of the open and close finger device which is implemented using a roller bearing.

### DESCRIPTION OF EMBODIMENTS

Hereinafter, an embodiment according to the present disclosure will be described with reference to the drawings. In the following description, terms expressing relative positions or orientations, such as top, bottom, left, and right, are used to denote relative positions or orientations shown in the drawing which is referred to in the description unless otherwise specified.

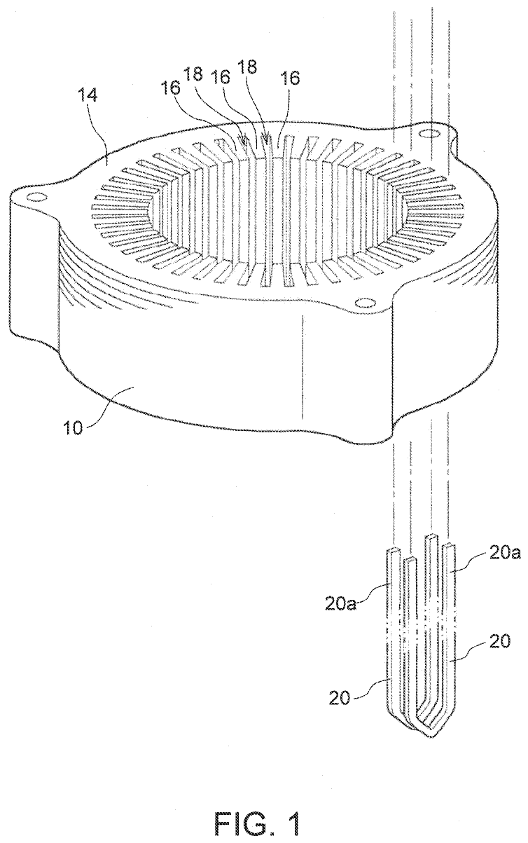

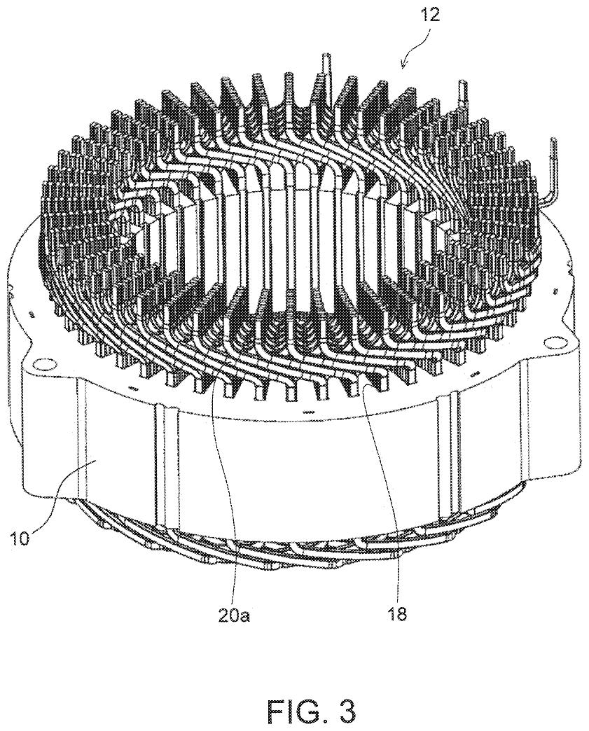

FIGS. 1 to 3 are drawings for explaining a process of forming a coil 12 (shown in FIG. 3) on a core, in particular, a stator core 10 in a rotary electric machine. The stator core 10 includes a yoke 14 formed in a substantially cylindrical shape and a plurality of teeth 16 extending radially inward from the yoke 14. The plurality of teeth 16 are spaced from each other and arranged along a circumferential direction, and a space between adjacent teeth 16 is referred to as a slot 18.

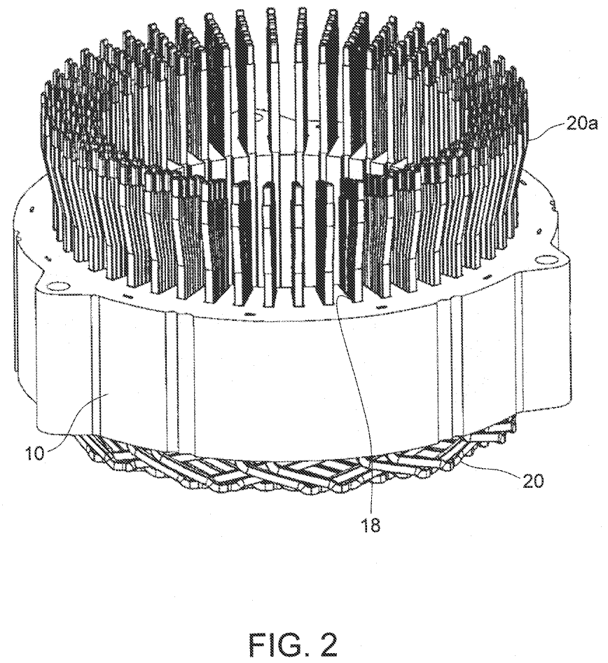

The coil 12 is formed by joining a plurality of coil wires 20 which are formed in the shape of a letter U. Each of the plurality of the coil wires 20 having the U letter shape is also referred to as a coil segment 20. The coil segment 20 is formed by bending a wire having a rectangular shape in cross section that is a so-called rectangular wire into the shape of the letter U as shown in FIG. 1, FIG. 1 shows two coil segments 20. FIG. 2 shows a plurality of coil segments 20 in a state where two arm portions 20a of the U letter shape in each of the plurality of coil segments 20 are inserted into slots 18. The two arm portions 20a of one coil segment 20 are respectively inserted into different slots 18 and end regions of the arm portions 20a are protruded from the slots 18. The end regions, which are protruded from the slots 18, of the arm portions 20a in the coil segment 20 are partially bent to the circumferential direction as shown in FIG. 3, and ends of predetermined arm portions 20a are joined to each other, for example, by welding to form the coil 12 composed of a plurality of continuous coil segments 20.

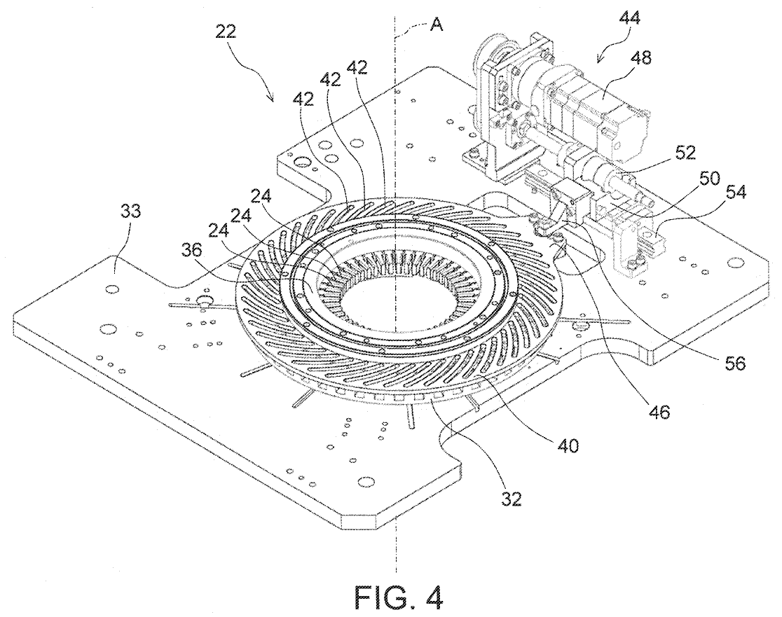

FIG. 4 shows an open and close finger device 22. The open and close finger device 22 includes a plurality of guide fingers 24 (hereinafter simply referred to as “fingers 24”) for guiding the coil segments 20 when the coil segments 20 are respectively inserted into the slots 18. The plurality of fingers 24 are arranged in an array along the circumferential direction at positions corresponding to the teeth 16, and can be placed as a whole in a closed state in which each of the plurality of fingers 24 is advanced inward in a radial direction, and in an open state in which each of the plurality of fingers 24 is retracted outward in the radial direction.

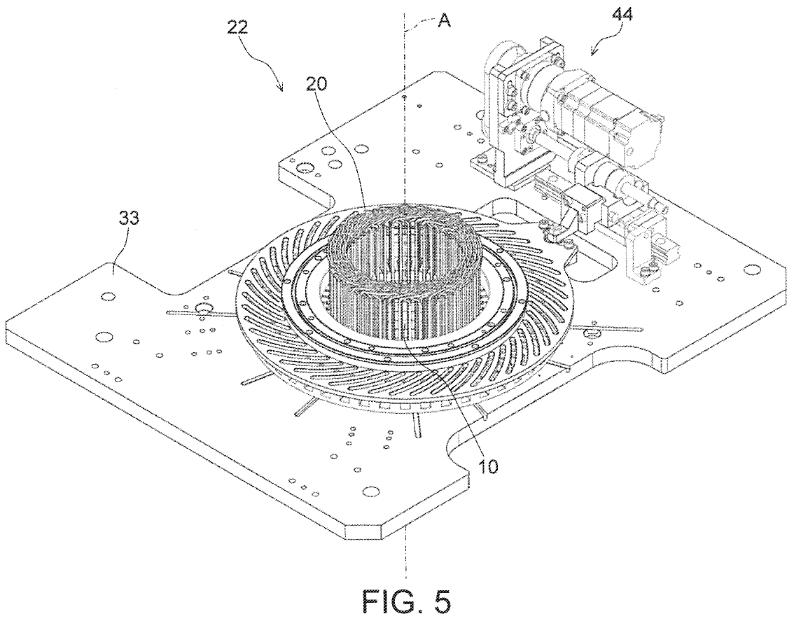

FIG. 5 shows an intermediate state in a process of mounting the coil segments 20 in the stator core 10 by means of the open and close finger device 22. In FIG. 5, the stator core 10 and the coil segments 20 are turned upside down from those shown in FIGS. 1 to 3. The stator core 10 is disposed below the open and close finger device 22 in FIG. 5, and each of the fingers 24 is positioned on an end surface of corresponding one of the teeth 16. The fingers 24 are in the closed position and are thus radially advanced along the teeth 16 extending inward in the radial direction, to cover the end surfaces of the teeth 16.

In a state where the stator core 10 and the open and close finger device 22 are placed in position to mount the coil segments 20 in the stator core 10, a direction in which a center axis A of the stator core 10 extends is defined as the “axial direction”, a direction in which the stator core 10 is turned about the center axis A is defined as the “circumferential direction”, and a direction orthogonal to the center axis A is defined as the “radial direction”.

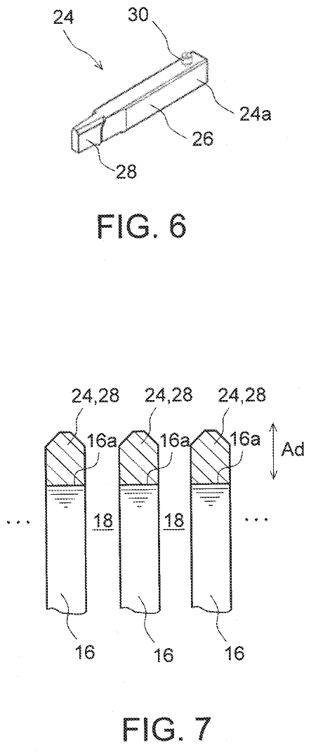

FIG. 6 is a diagram showing the finger 24 as a single piece isolated from others, and FIG. 7 is a cross sectional diagram of the fingers 24 located in the closed position; i.e., in positions aligned with the end surfaces, in particular, the teeth 16 of the stator core 10. In FIG. 7, an arrow Ad shows a direction along the center axis A, and the direction indicated by the arrow Ad is referred to as a center axis direction Ad. The finger 24 is composed of a mostly rod-shaped member which is rectangular in cross section, and includes a trunk part 26 and a tip part 28 extending radially inward from the trunk part 26. When the coil segment 20 is mounted on the stator core 10, the tip part 28 is placed on an end surface 16a of the tooth 16 in the center axis direction Ad. A bottom surface, in FIG. 7, of the tip part 28 has the same shape as the end surface 16a of the tooth 16, and the tip part 28 and the tooth 16 are integrated into one unit when the tip part 28 is placed on the end surface 16a of the tooth 16. Another surface (a top surface in FIG. 7) of the tip part 28 located opposite the tooth 16 is chamfered on both side edges. In this way, the tip part 28 is configured to guide the coil segment 20 when the coil segment 20 is inserted from above the tip part 28, as shown in FIG. 7, into the slots 18, and accordingly protect edges of the end surface 16a of the tooth 16 from being brought into contact with the coil segment 20 during insertion of the coil segment 20. In a case where an insulation film is formed on the coil segment 20, preventing physical contact of the coil segment 2 and the edges of the tooth 16 can in turn prevent the insulation film from getting damaged.

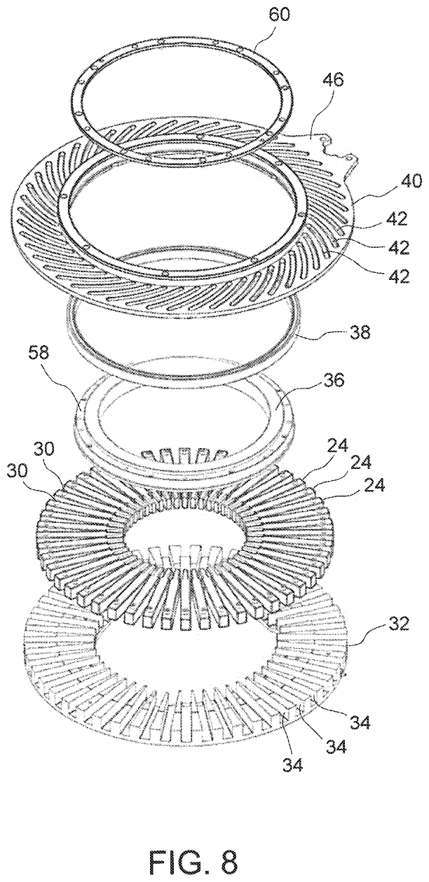

A cam follower 30 composed of a cylindrical or columnar protrusion is fixed to a base end opposite to the tip part 28 of the trunk part of the finger 24. The cam follower 30 is fitted a cam slot 42 (shown in FIG. 8) formed in a cam plate 40 which will be described below. The trunk part 26 of the finger 24 has a substantially constant dimension in the center axis direction Ad; i.e., a substantially constant height, and a height of a region of the finger 24 equipped with the cam follower 30 that is referred to as a follower fixing region 24a is equal to a height of an adjacent region located on a radially inner side of the follower fixing region 24a. Accordingly, stiffness of the follower fixing region 24a is greater than that in a case where the follower fixing part 24a has a dimension smaller than the adjacent region.

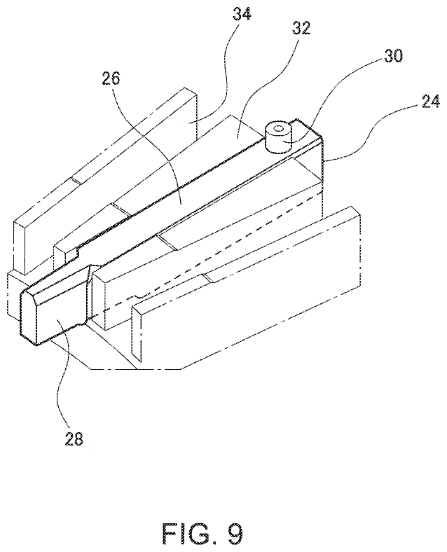

FIG. 8 is a perspective view showing main components of the open and close finger device 22 in an exploded state. The fingers 24 are respectively housed in guide grooves 34 formed in a finger guide 32. The finger guide 32 is fixed to a base plate 33 (shown in FIG. 4) of the open and close finger device 22. The finger guide 32 is formed in a substantially annular plate shape and is placed in such a manner that a center axis of the finger guide 32 is coincide with the center axis A. The guide grooves 34 are formed in a radial pattern on a top surface of the finger guide 32, and the number of the guide grooves 34 is equal to that of the fingers 24. Each of the guide grooves 34 extends along the radial direction, and houses corresponding one of the fingers 24, in particular, the trunk part 26 of the finger 24 as shown in FIG. 9. The width of the guide grooves 34 is equal to the width of the trunk parts 26 of the fingers 24. The guide grooves 34 function to guide radial movement of the fingers 24.

A substantially annular shaped cap 36 is arranged concentrically with respect to the finger guide 32 in a position aligned with an inner circumference of the finger guide 32, and is coupled to the finger guide 32. The cap 36 covers the guide grooves 34 in a radially inner region of the finger guide 32 to maintain the fingers 24 housed in the guide grooves 34 remaining therein. The cam plate 40 formed in a substantially annular shape is arranged concentrically with the cap 36, and is connected via a bearing 38 to the cap 36 in a state capable of being turned along the circumferential direction.

The cam plate 40 has cam slots 42 which extend in an inclined state relative to the radial direction, and the number of cam slots 42 is equal to that of the fingers 24. Each of the cam slots 42 is curved to maintain the same angle of inclination relative to the radial direction at any point in the cam slot 42. Further, the cam slots 42 are formed in a shape of a long hole penetrating through the cam plate 40 in a thickness direction of the cam plate 40. The cam followers 30 fixed to the fingers 24 are respectively fitted in the cam slots 42. Because the cam followers 30 integral to the fingers 24 are only able to move along the radial direction, when the cam plate 40 is turned, the cam followers 30 are guided by the cam slots 42 and moved along the radial direction. This, in turn, causes the fingers 24 to move along the radial direction. A joint region 46 is disposed on an outer circumferential edge of the cam plate 40 for connection to an actuator 44 (shown in FIG. 4) which is configured to rotatably drive the cam plate 40.

Referring back to FIG. 4, the actuator 44 is explained below. The actuator 44 is placed on the base plate 33. The actuator 44 includes an electric motor 48 and a slider 50 driven by the electric motor 48. Rotary motion created by the electric motor 48 is transformed via a transfer mechanism equipped with a ball screw 52 into linear motion for linearly driving the slider 50 along a guide rail 54. A joint piece 56 which is coupled to the joint region 46 of the cam plate 40 is fixed to the slider 50. The linear motion of the slider 50 causes the cam plate 40 to be turned around the center axis A. Coupling between the joint piece 56 which is linearly moved and the joint region 46 which is circularly moved in an arc path is achieved by means of an arrangement for allowing both linear and circular movement.

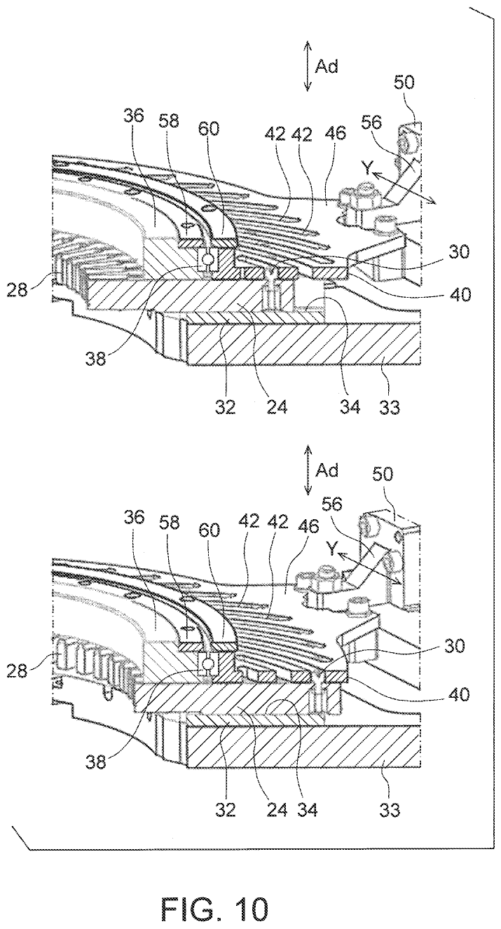

FIG. 10 is a cross section view showing main components of the open and close finger device 22. In an upper region of FIG. 10, the fingers 24 are shown in the closed state of being advanced inward in the radial direction, and in a lower region of FIG. 10, the fingers 24 are shown in the open state of being retracted outward in the radial direction.

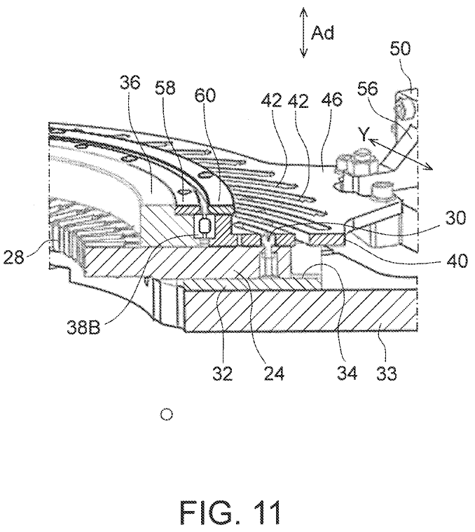

On the base plate 33, the finger guide 32 is fixedly mounted, and the fingers 24 are housed in the guide grooves 34 of the finger guide 32. On the finger guide 32, the cap 36 is fixed to an upper surface, in particular, a radially inner part of the upper surface of the finger guide 32, and the cam plate 40 is placed on a radially outer part of the upper surface. A bearing 38 which is a radial bearing is arranged between the cap 36 and the cam plate 40 in the radial direction, to guide the cam plate 40 when the cam plate 40 is turned around the cap 36. The bearing 38 is a ball bearing, while a roller bearing, such as a bearing 38B shown in FIG. 11, may be used for the bearing 38. An inner ring of the bearing 38 is placed between a flange provided to a lower end of an outer circumferential surface of the cap 36 and an inner ring retainer 58 fixed to a top surface of the cap 36, so as to be retained by the flange and the inner ring retainer 58. On the other hand, an outer ring of the bearing 38 is placed between a flange provided to a lower end of an inner circumferential surface of the cam plate 40 and an outer ring retainer 60 fixed to a top surface of the cam plate 40, so as to be retained by the flange and the outer ring retainer 60.

When the slider 50 is moved on the guide rail 54, the movement of the slider 50 is transferred to the cam plate 40 via the joint piece 56 and the joint region 46 of the cam plate 40, and the cam plate 40 is accordingly turned along the circumferential direction. When the slider 50 is moved toward an upper left region along a direction indicated by an arrow Y in FIG. 10 from a state where the fingers 24 are in the advanced position illustrated in the upper region of FIG. 10, the cam plate 40 is turned in a counterclockwise direction when viewed from above in FIG. 10, which causes the cam followers 30 to be moved toward the right; i.e. outward in the radial direction while being respectively guided by the cam slots 42. Then, the fingers 24 are also moved to be retracted outward in the radial direction together with the cam followers 30, and brought into the retracted state illustrated in the lower region of FIG. 10, On the other hand, when the slider 50 is moved toward a lower right region along the direction indicated by the arrow Y from a state where the fingers 24 are in the retracted position shown in the lower region of FIG. 10, the cam plate 40 is turned in a clockwise direction, which causes the cam followers 30 to be moved inward in the radial direction while being respectively guided by the cam slots 42. Then, the fingers 24 are also moved to be advanced inward in the radial direction together with the cam followers 30, and brought into the advanced state illustrated in the upper region of FIG. 10.

Next, a process of inserting the coil segments 20 into the stator core 10 is described. In an initial step, the stator core 10 is placed in position with respect to the open and close finger device 22, and the fingers 24 are set to the closed position. In the closed position, the fingers 24 are positioned on the end surfaces 16a of the teeth 16 so as to be aligned therewith. In a next step, the arm portions 20a of the coil segments 20 are inserted from the fingers 24 toward the stator core 10. During the step of insertion, the fingers 24 are moved to the open position before bottom portions of the letter U of the coil segments 20 are brought into contact with the fingers 24. In a next step, the stator core 10 equipped with the coil segments 20 is removed from the open and close finger device 22.

When the cam plate 40 is turned, movement of the cam plate 40 is smoothened by the bearing 38 which is provided to guide the cam plate 40. As a result, the cam plate 40 and neighboring components which are arranged adjacent to the cam plate 40 and are thus physically in contact therewith are made less prone to abrasion.

### REFERENCE SIGNS LIST

10 stator core; 12 coil; 16 tooth; 16a end surface; 18 slot; 20 coil segment (coil wire); 22 open and close finger device; 24 finger; 26 trunk part; 28 tip part; 30 cam follower; 32 finger guide; 33 base plate; 34 guide groove; 36 cap; 38, 38B bearing; 40 cam plate; 42 cam slot; 44 actuator; 46 joint region; 48 electric motor; 50 slider; 56 joint piece; 58 inner ring retainer; 60 outer ring retainer; A center axis.

1. An open and close finger device, comprising:
fingers arranged to be respectively aligned with end surfaces of teeth in a core of a rotary electric machine, the fingers being configured to guide coil wires, which are wound around the core, when the coil wires are inserted into slots, each of which is defined by a space between adjacent teeth among the teeth in the core;
a finger guide including guide grooves which are arranged in an array along a circumferential direction and configured to respectively house the fingers, the guide grooves extending along a radial direction to thereby guide radial movement of the fingers;
a cam plate formed in an annular plate shape and including cam slots, each of which is inclined relative to the radial direction and is configured to fittingly receive a cam follower which is fixed to corresponding one of the fingers;
a cap placed in a fixed position with respect to the finger guide and configured to define an axis of turn of the cam plate which is turned along a circumferential direction;
a bearing disposed between the cap and the cam plate to guide the turn of the cam plate along the circumferential direction; and
an actuator configured to turn the cam plate for causing the fingers to be advanced and retracted in the radial direction, wherein the fingers having been advanced are placed on the end surfaces of the teeth so as to be aligned with the end surfaces.

2. The open and close finger device according to claim 1, wherein the bearing is a ball bearing.

3. The open and close finger device according to claim 1, wherein the bearing is a roller bearing.

4. The open and close finger device according to claim 1, wherein the cap is configured to partially cover open regions in the guide grooves, to retain the fingers within the guide grooves.

5. The open and close finger device according to claim 1, wherein the cap and the hearing are placed on a radially inner side of the cam plate.
